(19) United States
(12) Patent Application Publication
(10) Pub. No.: US 2025/0317736 A1
(43) Pub. Date: Oct. 9, 2025

(54) ACCESS POINT DEVICE LOCATION CHANGE DETERMINATION

(71) Applicant: Ruckus IP Holding LLC, Claremont, NC (US)

(72) Inventors: Jay STRATER, San Diego, CA (US); Kurt A. LUMBATIS, Dacula, GA (US); Gregory N. NAKANISHI, San Diego, CA (US); Charles P. CHEEVERS, Alpharetta, GA (US); James R. FLESCH, Doraville, GA (US)

(21) Appl. No.: 18/865,749

(22) PCT Filed: May 22, 2023
(86) PCT No.: PCT/US2023/023041

§ 371 Date: Nov. 14, 2024

Related U.S. Application Data
(60) Provisional application No. 63/345,089, filed on May 24, 2022.

(51) Int. Cl. H04W 12/104; H04L 61/5014; H04W 12/63

(52) U.S. Cl. CPC H04W 12/104; H04L 61/5014; H04W 12/63

(57) ABSTRACT

Inconsequential events, such as power outages in an area or an inadvertent disconnection, can cause a network device to send an AFC request message for a power allowance even if not necessary as no change in location has occurred and the required periodic power allowance time period has not expired. An enhanced network environment is provided by a location integrity system that detects a change in location of a network device. The location integrity system determines a baseline location and one or more baseline location integrity parameters associated with the network device. The one or more baseline location integrity parameters are used to determine the change in location of the network device when a power allowance event occurs. The location integrity system only sends or issues the periodic AFC request message when required due to expiration of the periodic power allowance time period or the network device has change location.

### BACKGROUND

Companies are increasingly providing Multiple Access Point (MAP) architecture or Home Network Controller (HNC) type of home wireless fidelity (Wi-Fi) management, with multiple access point devices and/or extender access point devices (collectively, network devices) at a premises, for example, a home, to improve Quality of Experience (QoE) of the user by offering extended coverage with seamless roaming. Access point devices and extender access point devices communicate with client devices using one or more RF channels. Typically, 5 GigaHertz (GHz) radio is used for Wi-Fi backhaul in extender access point devices because such offers more bandwidth with less interference and greater reliability when compared to 2.4 GHz radio. However, network architecture and user demands are creating a crowded space even for the 5 GHz frequency band. Even in the network environments where relatively high bitrate streaming traffic is shunted off of the 2.4 GHz frequency band to the 5 GHz frequency band, crowding in both pieces of the spectrum is becoming everyday more commonplace.

The 6 GHz frequency band for Wi-Fi 6E and on is providing some relief for the overcrowding of the 2.4 GHz and 5 GHz frequency bands. However, incumbent 6 GHz wireless infrastructures or systems, such as a fixed microwave system, may be located within a proximity of an indoor network device such that operation in the 6 GHz frequency band can be restricted by a governmental agency or regulatory group, such as by the Federal Communications Commission (FCC), to low power indoor (LPI) transmission levels when the device might otherwise be allowed to operate with higher Standard Power (SP) transmission levels in portions of the 6 GHz frequency band (for example, U-NII 5 and U-NII 7). If a network device is near but not in the path of an incumbent 6 GHz wireless infrastructure or systems, the network device can be restricted to low power indoor (LPI) transmission levels on all 6 GHz channels unless the network device can provide an accurate indication of the network device location to an Automated Frequency Coordination (AFC) management system that allocates transmission allowances. Therefore, there is a need to provide accurate location information that includes an uncertainty region for an indoor network device so as to enhance the Wi-Fi network experience for users by achieving higher power within portions of the 6 GHz frequency band, particularly when the users are near but not interfering with incumbent 6 GHz wireless infrastructures or systems.

### SUMMARY

Network environments, especially home network environments, can now serve multiple functions for various types of users and network devices. For example, the same network can be required support a variety of users that require differing amounts of access and bandwidth and multiple network. Given the various network activities that include substantial reliance on Internet access, especially indoor Wi-Fi or Internet access, and increased access to network resources, it is becoming imperative to provide optimized access to the network for all users and/or network devices seeking access to any number of network resources. With the availability of 6 GHz for Wi-Fi 6E and later solutions, an access point device can be developed to support 6 GHz frequency band over any of the Unlicensed National Information infrastructure (U-NII) 5, 6, 7, and 8 bands or any other U-NII band. However, use of the 6 GHz frequency band is restricted by the FCC (or one or more other governmental agencies) to LPI transmission levels without being under the control of an automated frequency coordination (AFC) management system, for example, to the maximum allowed equivalent isotropically radiated power (EIRP) of 30 decibel (dB)-milliwatts (dBm) or 5 dBm/MHz (MegaHertz) power spectral density. There is an option for higher Standard Power (SP) transmission levels for an access point device in the U-NII 5 and U-NII 7 bands indoors, for example, an effective isotropic radiated power (EIRP) of 36 dBm or maximum spectrum density of 23 dBm/MHz. However, this requires operation under the control of an AFC management system which maintains a database of the frequencies used by and geographical locations of the incumbent infrastructures or system. The AFC management system will assign a list of frequencies and transmission levels to the access point device, based on where the access point device can operate safely without interfering with any incumbent systems or infrastructures (for example fixed microwave receivers).

The Wi-Fi Alliance (WFA) developed an AFC management system to AFC Device Interface Specification to standardize the signaling needed for communication between an access point device and an AFC management system. The AFC Device Interface Specification includes fields for information associated with a location of the access point device (an access point device location) to be sent or transmitted by or for an access point device in an available spectrum inquiry request message. For example, an AFC request message, such as an available spectrum inquiry (ASI) request message, comprises a location and an uncertainty region within which the access point device is located based on the information associated with the access point device location. This uncertainty region can be defined as an ellipse, a linear polygon, a radial polygon, or any other shape. In certain circumstances, a large uncertainty region associated with an access point device is acceptable. However, when an access point device is disposed or positioned in proximity to, but not in the path of, an incumbent fixed microwave receiver, the accuracy of the uncertainty region (an error offset) is important such that the accuracy should be maximized so that the restriction on SP power allocation is minimized.

In response to an AFC request message, the AFC management system sends an AFC response that comprises a power allowance, such as an EIRP and associated one or more spectrum allowances. The power allowance can have an associated time limitation (for example, twenty-four hours) such that a new AFC request message is needed periodically (a renewal request). Naturally, if there is no change in device location, such an AFC request message for renewal would utilize the existing network device location information. However, if there is a change in location of the network device, this new location of the network device must be used in the next AFC request message by the network device. Determining an accurate location of the network device provides an improved or enhanced network environment experience as an accurate location is key so as to maximize the power allowance received from the AFC management system.

A network device that is required to operate within one or more AFC constraints, such as an access point device, must set a power allowance for 6 GHz operation based on a power allowance from an AFC management system, for example, after occurrence of one or more power allowance events. The one or more power allowance events can comprise any of an initialization, a configuration, a setup, a reboot or a restart, a power sequence, a location change (the network device has been transitioned to a different site or within a site), an expiration of a power allowance time period (for example, at a predetermined or required periodic time interval, such as every twenty-four hours), or any combination thereof. Each network device in a network can be associated with one or more power allowance events. One or more novel solutions of the present disclosure provide for a determination of a change in location of such a network device using one or more location integrity parameters. This determination is needed to determine that the location information previously determined for the network device can be reused in an AFC request message (an AFC renewal request message) or that new or subsequent location information for the network device must be obtained and an AFC request message sent to obtain a power allowance associated with the network device. When the AFC request message is required to be sent, the AFC request message comprises location information associated with access point device. The location information can comprise any of an error offset associated with an access point device, global position system (GPS) information obtained from the access point device, GPS location information obtained from a proxy device (such as a client device (for example, any type of mobile device)) and/or WFA Wi-Fi Location information between the proxy device and the access point device), or any combination thereof based on the current location of the network device. Such location information minimizes a user involvement in a determination of an access point device location and reduces network traffic/increases network performance as the AFC request message for a power allowance associated with the network device need only be sent when a power allowance event occurs.

An aspect of the present disclosure provides a method for a client device determine a change in a location of an access point device. The method comprises determining one or more baseline location integrity parameters associated with the access point device, determining that a power allowance event associated with the access point device has occurred, determining one or more current location integrity parameters associated with the access point device based on the power allowance event, detecting the change in the location of the access point device based on a comparison of the one or more current location integrity parameters to the one or more baseline location integrity parameters, sending an AFC request message to an AFC management system based on the change in the location, receiving an AFC response message from the AFC management system, wherein the AFC response message comprises the power allowance for the access point device, and configuring the access point device based on the AFC response message.

In an aspect of the present disclosure, the method further comprises updating the one or more baseline location integrity parameters with the one or more current location integrity parameters, and storing the one or more baseline location integrity parameters.

In an aspect of the present disclosure, the method is such that the updating the one or more baseline location integrity parameters is based on a timestamp associated with the one or more current location integrity parameters.

In an aspect of the present disclosure, the method is such that at least one of the power allowance event comprises any of a reboot, a power sequence, a location change, or any combination thereof, and the one or more location integrity parameters comprise one or more inter-site parameters, one or more intra-site parameters, and a timestamp.

In an aspect of the present disclosure, the method is such that the one or more inter-site parameters comprise any of a network node address, a visible neighbor reporting, a wide area network (WAN) dynamic host configuration protocol (DHCP) server response information, a network server traceroute, a global positioning system information, a user information, a user input information, or any combination thereof.

In an aspect of the present disclosure, the method is such that the one or more intra-site parameters comprise any of one or more performance indicators, a signal strength visible neighbor reporting, one or more wireless fidelity sensing return variation parameters, a fixed client device information, or any combination thereof.

In an aspect of the present disclosure, the method is such that the comparison indicates that a difference of at least one of the one or more location integrity parameters and a corresponding at least one of the one or more current location integrity parameters is at or above an associated threshold.

An aspect of the present disclosure provides a location integrity system that comprises a memory and a processor. The memory storing one or more computer-readable instructions and the processor configured to execute the one or more computer-readable instructions to cause the location integrity system to determine one or more baseline location integrity parameters associated with the access point device, determine that a power allowance event associated with the access point device has occurred, determine one or more current location integrity parameters associated with the access point device based on the power allowance event, detect the change in the location of the access point device based on a comparison of the one or more current location integrity parameters to the one or more baseline location integrity parameters, send an AFC request message to an AFC management system based on the change in the location, receive an AFC response message from the AFC management system, wherein the AFC response message comprises the power allowance for the access point device, and configure the access point device based on the AFC response message.

In an aspect of the present disclosure, the processor is further configured to execute the one or more instructions to further cause the location integrity system to update the one or more baseline location integrity parameters with the one or more current location integrity parameters, and store the one or more baseline location integrity parameters.

In an aspect of the present disclosure, the updating the one or more baseline location integrity parameters is based on a timestamp associated with the one or more current location integrity parameters.

In an aspect of the present disclosure, wherein at least one of the power allowance event comprises any of a reboot, a power sequence, a location change, or any combination thereof, and the one or more location integrity parameters comprise one or more inter-site parameters, one or more intra-site parameters, and a timestamp.

In an aspect of the present disclosure, wherein the one or more inter-site parameters comprise any of a network node address, a visible neighbor reporting, a wide area network (WAN) dynamic host configuration protocol (DHCP) server response information, a network server traceroute, a global positioning system information, a user information, a user input information, or any combination thereof.

In an aspect of the present disclosure, wherein the one or more intra-site parameters comprise any of one or more performance indicators, a signal strength visible neighbor reporting, one or more wireless fidelity sensing return variation parameters, a fixed client device information, or any combination thereof.

In an aspect of the present disclosure, wherein the comparison indicates that a difference of at least one of the one or more location integrity parameters and a corresponding at least one of the one or more current location integrity parameters is at or above an associated threshold.

An aspect of the present disclosure provides a non-transitory computer-readable medium of a location integrity system storing one or more computer-readable instructions for configuring a power allowance for an access point device. The one or more computer-readable instructions, that when executed by a processor, cause the processor to perform one or more operations including the steps of the methods described above.

The above-described network device(s) or electronic apparatus(es), such as access point devices, extender access point devices, client devices and any other network devices, may be implemented as any of a residential network access point device, an electronic device (for example, a mobile phone, a computing device such as a notebook computer, or both) according to one or more embodiments.

Thus, according to various aspects of the present disclosure described herein, it is possible to configure an access point device to utilize the 6 GHz frequency band of a network without interfering with incumbent 6 GHz wireless infrastructures or systems within proximity of the access point device using a location integrity system.

### BRIEF DESCRIPTION OF DRAWINGS

In the drawings, like reference numbers generally indicate identical, functionally similar, and/or structurally similar elements.

FIG. 1 is a schematic diagram of a network environment, according to one or more aspects of the present disclosure;

FIG. 2 is a more detailed block diagram illustrating various components of an exemplary access point device, client device, and extender access point device implemented in the network environment of FIG. 1, according to one or more aspects of the present disclosure;

FIG. 3 is a block diagram illustrating a location integrity system for use in determining a change in location information of an access point device of a network, according to one or more aspects of the present disclosure;

FIGS. 4A, 4B, and 4C illustrate a diagram for one or more location integrity parameters of a location integrity system for use in determining a change in a location of an access point device in a network environment, according to one or more aspects of the present disclosure;

FIG. 5 is a flow diagram for detecting a change in location of an access point device in a network using a location integrity system, according to one or more aspects of the present disclosure; and

FIG. 6 is a flow chart illustrating a method for determine a change in a location of an access point device, according to one or more aspects of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

To improve network performance, one or more novel solutions are provided to determine a change in a location of an access point device.

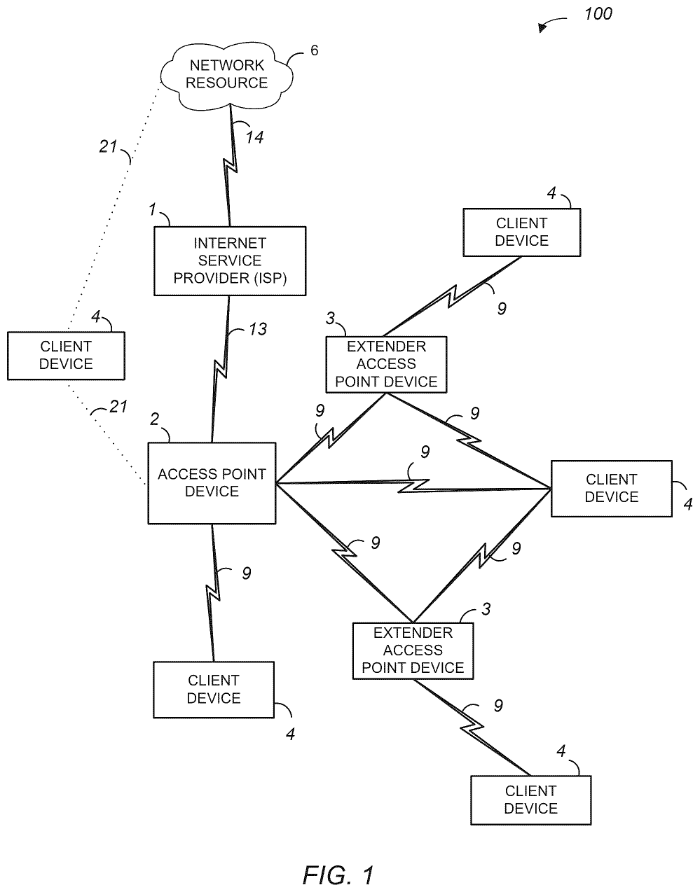

FIG. 1 is a schematic diagram of a network environment 100, according to one or more aspects of the present disclosure.

It should be appreciated that various example embodiments of inventive concepts disclosed herein are not limited to specific numbers or combinations of devices, and there may be one or multiple of some of the aforementioned electronic apparatuses or network devices in the network environment, which may itself consist of multiple communication networks and various known or future developed wireless connectivity technologies, protocols, devices, and the like.

As shown in FIG. 1, the main elements of the network environment 100 include a network comprising an access point device 2 connected to a network resource 6, such as a cloud-based repository, via an Internet Service Provider (ISP) 1 and also connected to different wireless devices or network devices such as one or more wireless extender access point devices 3 and one or more client devices 4. The network environment 100 shown in FIG. 1 includes wired and/or wireless network devices (e.g., extender access point devices 3 and client devices 4) that may be connected in one or more wireless networks (for example, private, guest, iControl, backhaul network, or Internet of things (IoT) network) within the network environment 100. Additionally, there could be some overlap between network devices (for example, extender access point devices 3 and client devices 4) in the different networks. That is, one or more network or wireless devices could be located in more than one network. For example, the extender access point devices 3 could be located both in a private network for providing content and information to a client device 4 and also included in a backhaul network or an iControl network.

The ISP 1 can be, for example, a content provider or any computer for connecting the access point device 2 to the network resource 6. For example, network resource 6 can be a cloud-based service that provides access to a cloud-based repository, a governmental or other database, such as an AFC database (for example, an AFC resource associated with an AFC management system), that provides information associated with operations within the 6 GHz wireless frequency band, a location service for providing topographical information, for example, topographical information associated with a coordinate, such as a z-coordinate associated with a location indicated by an x-y coordinate, any other repository, or any combination thereof that is accessible via ISP 1. In one or more embodiments, network resource 6 may be accessible via a cellular communications service provider. The connection 14 between the network resource 6 and the ISP 1 and the connection 13 between the ISP 1 and the access point device 2 can be implemented using a wide area network (WAN), a virtual private network (VPN), metropolitan area networks (MANs), system area networks (SANs), a data over cable service interface specification (DOCSIS) network, a fiber optics network (e.g., FTTH (fiber to the home) or FTTX (fiber to the x), or hybrid fiber-coaxial (HFC)), a digital subscriber line (DSL), a public switched data network (PSDN), a global Telex network, or a 2G, 3G, 4G, 5G, or 6G network, for example.

The connection 13 can further include as some portion thereof a broadband mobile phone network connection, an optical network connection, or other similar connections. For example, the connection 13 can also be implemented using a fixed wireless connection that operates in accordance with, but is not limited to, 3rd Generation Partnership Project (3GPP) Long Term Evolution (LTE), 5G, or 6G protocols. It is also contemplated by the present disclosure that connection 13 is capable of providing connections between the access point device 2 and a WAN, a LAN, a VPN, MANS, PANs, WLANs, SANs, a DOCSIS network, a fiber optics network (e.g., FTTH, FTTX, or HFC), a PSDN, a global Telex network, or a 2G, 3G, 4G, 5G or 6G network, for example.

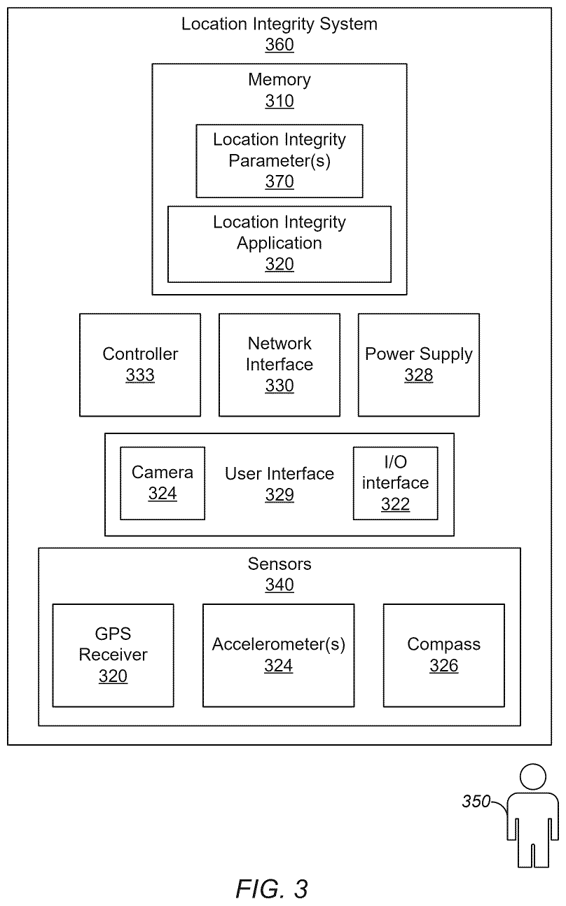

The access point device 2 can be, for example, an access point and/or a hardware electronic device that may be a combination modem and gateway that combines the functions of a modem, an access point (AP), and/or a router for providing content received from the ISP 1 to one or more network devices (for example, wireless extender access point devices 3 and client devices 4) in the network environment 100. In one or more embodiments, a network device, such as the access point device 2 and/or the extender access point device 3, has a transmission power (Tx) configured for the access point device 2 beyond LPI power levels based on AFC feedback for a location of the access point device 2, for example, a location determined by a location integrity system 360 as discussed with reference to FIG. 3. It is also contemplated by the present disclosure that the access point device 2 can include the function of, but is not limited to, a universal plug and play (UPnP) simple network management protocol (SNMP), an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content. The access point device 2 may also be referred to as a residential gateway, a home network gateway, or a wireless access point (AP).

The connection 9 between the access point device 2, the wireless extender access point devices 3, and client devices 4 can be implemented using a wireless connection in accordance with any IEEE 802.11 Wi-Fi protocols, Bluetooth protocols, BLE, or other short range protocols that operate in accordance with a wireless technology standard for exchanging data over short distances using any licensed or unlicensed band such as the citizens broadband radio service (CBRS) band, 2.4 GHz bands, 5 GHz bands, 6 GHz bands, or 60 GHz bands. Additionally, the connection 9 can be implemented using a wireless connection that operates in accordance with, but is not limited to, RF4CE protocol, ZigBee protocol, Z-Wave protocol, or IEEE 802.15.4 protocol. It is also contemplated by the present disclosure that the connection 9 can include connections to a media over coax (MoCA) network. One or more of the connections 9 can also be a wired Ethernet connection. Any one or more of connections 9 can carry information on any of one or more channels that are available for use. Connection 9 can be a secure connection that prevents or thwarts unauthorized or unwanted access.

The extender access point devices 3 can be, for example, wireless hardware electronic devices such as access points (APs), extenders, repeaters, etc. used to extend the wireless network by receiving the signals transmitted by the access point device 2 and rebroadcasting the signals to, for example, client devices 4, which may be out of range of the access point device 2. The extender access point devices 3 can also receive signals from the client devices 4 and rebroadcast the signals to the access point device 2, or other client devices 4.

The client devices 4 can be, for example, any type of proxy device, such as any of hand-held computing devices, personal computers, electronic tablets, mobile phones, smart phones, smart speakers, Internet-of-Things (IoT) devices, iControl devices, portable music players with smart capabilities capable of connecting to the Internet, cellular networks, and interconnecting with other devices via Wi-Fi and Bluetooth, other wireless hand-held consumer electronic devices capable of accessing a wireless network, or any combination thereof. For example, any one or more client devices 4 can be a mobile network device capable of connecting to a wireless network and configuring a power allowance (a transmission power) of an access point device 2 that is beyond LPI power levels based on AFC feedback, such as an AFC response message, for a location determined for the access point device 2 by the client device 4. Additionally, any one or more client devices 4 can be a television (TV), an IP/QAM set-top box (STB) or a streaming media decoder that is capable of decoding audio/video content, and playing over OTT or MSO provided content received through the access point device 2. In one or more embodiments, a client device 4 is a network device that comprises a location integrity system (as discussed with reference to FIG. 3) for determining a change in location of an access point device 2 and sending an AFC request message based on determined change in location. A client device 4, such as a proxy device as a location integrity system, can be connected to a network resource 6, such as an AFC management system, and to the access point device 2 via a connection 21. Connection 21 can be the same as or similar to any one or more other connections discussed with reference to FIG. 1, such as connection 14.

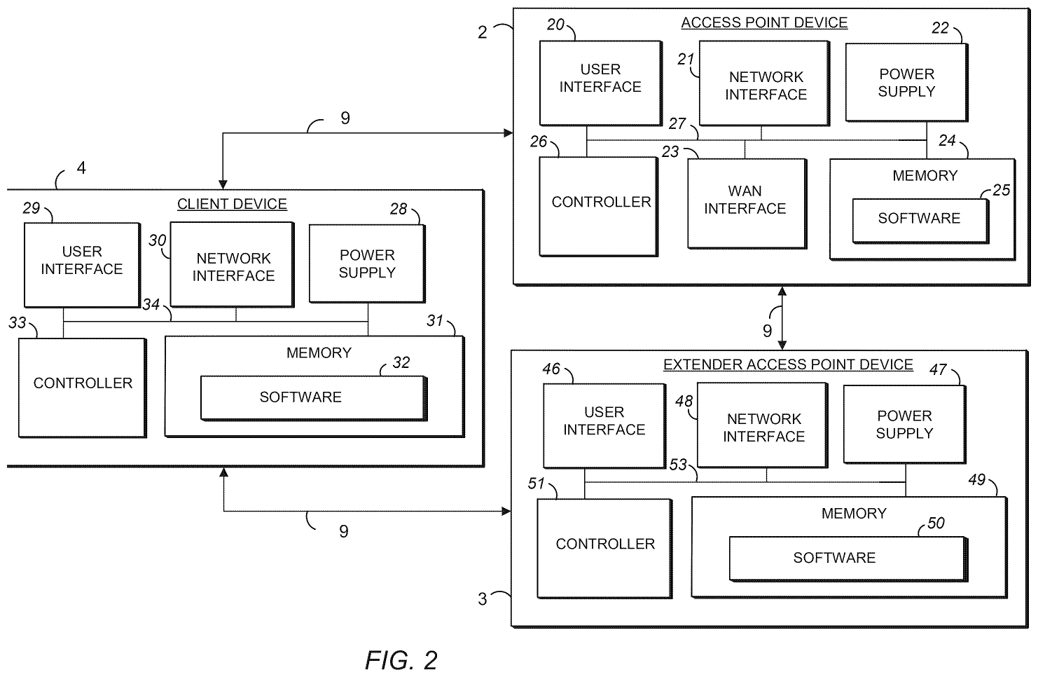

A detailed description of the exemplary internal components of the access point device 2, the extender access point devices 3, and the client devices 4 shown in FIG. 1 will be provided in the discussion of FIG. 2. However, in general, it is contemplated by the present disclosure that the access point device 2, the extender access point devices 3, and the client devices 4 include electronic components or electronic computing devices operable to receive, transmit, process, store, and/or manage data and information associated with the network environment 100, which encompasses any suitable processing device adapted to perform computing tasks consistent with the execution of computer-readable instructions stored in a memory or a computer-readable recording medium (for example, a non-transitory computer-readable medium).

Further, any, all, or some of the computing components in the access point device 2, the extender access point devices 3, and the client devices 4 may be adapted to execute any operating system, including Linux, UNIX, Windows, MacOS, DOS, and ChromOS as well as virtual machines adapted to virtualize execution of a particular operating system, including customized and proprietary operating systems. The access point device 2, the extender access point devices 3, and the client devices 4 are further equipped with components to facilitate communication with other computing devices or network devices over the one or more network connections to local and wide area networks, wireless and wired networks, public and private networks, and any other communication network enabling communication in the network environment 100.

FIG. 2 is a more detailed block diagram illustrating various components of an exemplary access point device, client device, and wireless extender implemented in the network environment 100 of FIG. 1, according to one or more aspects of the present disclosure.

Although FIG. 2 only shows one extender access point device 3 and one client device 4, the extender access point device 3 and the client device 4 shown in the figure are meant to be representative of the other extender access point devices 3 and client devices 4 of a network system, for example, network environment 100 shown in FIG. 1. Similarly, the connections 9 between the access point device 2, the extender access point device 3, and the client device 4 shown in FIG. 2 are meant to be exemplary connections and are not meant to indicate all possible connections between the access point devices 2, extender access point devices 3, and client devices 4. Additionally, it is contemplated by the present disclosure that the number of access point devices 2, extender access point devices 3, and client devices 4 is not limited to the number of access point devices 2, extender access point devices 3, and client devices 4 shown in FIGS. 1 and 2.

The client device 4 includes a power supply 28, a user interface 29, a network interface 30, a memory 31, and a controller 33. The client device 4 can be, for example, a computer, a portable device, an electronic tablet, an e-reader, a PDA, a mobile phone such as a smart phone, a smart speaker, an IoT device, an iControl device, portable music player with smart capabilities capable of connecting to the Internet, cellular networks, interconnecting with other devices via Wi-Fi and Bluetooth, any network device capable of receiving and/or generating one or more GPS measurements, or other wireless hand-held consumer electronic device capable of communicating with access point device 2, a network resource 6 or any other network device. In one or more embodiments, a client device 4 is a mobile network device, such as a smart phone, capable of determining a location of the access point device 2 and configuring an access point device 2 such that the access point device 2 can provide a 6 GHz wireless frequency band network. The client device 4 can communicate with one or more resources 6 to obtain the necessary information for configuration of the access point device 2, such as a power allowance, according to one or more aspects of the present disclosure.

The power supply 28 supplies power to the internal components of the client device 4 through the internal bus 34. The power supply 28 can be a self-contained power source such as a battery pack with an interface to be powered through an electrical charger connected to an outlet (e.g., either directly or by way of another device). The power supply 28 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The user interface 29 includes, but is not limited to, push buttons, a keyboard, a keypad, a liquid crystal display (LCD), a thin film transistor (TFT), a light-emitting diode (LED), a high definition (HD) or other similar display device including a display device having touch screen capabilities so as to allow interaction between a user 350 and the client device 4, for example, for a user 350 to enter any one or more parameters that can be stored in memory 31, such as one or more location parameters 316 of an access point device 2 as discussed with reference to FIG. 3. In one or more embodiments, user interface 29 provides an interface for a user 350, such as a graphical user interface, to interact with a configuration application, for example, software 32, to provision or commission an access point device 2 to provide a 6 GHz wireless frequency band network. The network interface 30 can include, but is not limited to, various network cards, interfaces, and circuitry implemented in software and/or hardware to enable communications with the access point device 2, the extender access point device 3, ISP 1, and/or network resource 6 using any one or more of the communication protocols in accordance with connection 9 (for example, as described with reference to FIG. 1).

The memory 31 can be a non-transitory computer-readable medium that includes a single memory, one or more memories, or one or more memory locations. The memory 31 can include, but is not limited to, a random access memory (RAM), a dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), a hard disk or any other various layers of memory hierarchy. The memory 31 can be used to store any type of instructions, software, or algorithms including software 32 for controlling the general function and operations of the client device 4 in accordance with the embodiments described in the present disclosure. In one or more embodiments, software 32 can be or be part of a location integrity system 360, a location integrity application 320, or both as discussed with reference to FIG. 3. Memory 31 can store the software 32 and information used by the location integrity system 360, the one or more location integrity parameters 370, or both to configure an access point device 2 to utilize the 6 GHz wireless frequency band at a power level that does not interfere with an incumbent fixed microwave receiver also referred to as an incumbent 6 GHz wireless infrastructures or systems. In one or more embodiments, client device 4 is a network device, such as a mobile or smart phone, and software 32 includes one or more computer-readable instructions for establishing a connection with the access point device 2 so that the software 32 (such as the location integrity application 320) can any of determine a change in location associated with the access point device 2, receive one or more measurements associated with a location of the access point device 2 (such as, any of one or more GPS measurements, one or more Wi-Fi Location Fine Timing measurements, any other measurements (such as information from a network resource 6), or any combination thereof), determine a signal strength associated with the access point device 2, obtain any other information, make any other determination associated with configuring the access point device 2, configure the access point device 2, or any combination thereof. Information can include data or information associated with configuring the access point device 2, for example, any of topographical data, EIRP data, power allowance, any other coordinate information, or a combination thereof.

The controller 33 controls the general operations of the client device 4 and includes, but is not limited to, a central processing unit (CPU), a hardware microprocessor, a hardware processor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software including the software 32 for controlling the operation and functions of the client device 4 in accordance with the embodiments described in the present disclosure, such as determining a change in location of and/or configuring an access point device 2. Communication between the components (for example, 28-31 and 33) of the client device 4 may be established using an internal bus 34.

As shown in FIG. 2, the extender access point device 3 includes a user interface 46, a power supply 47, a network interface 48, a memory 49, and a controller 51. The extender access point device 3 can be, for example, any wireless hardware electronic device used to extend a wireless network by receiving the signals transmitted by the access point device 2 and rebroadcasting the signals to any one or more client devices 4, which may be out of range of the access point device 2 including, but not limited to, a wireless extender, a repeater, and/or an access point. The extender access point device 3 can also receive signals from any one or more of the client devices 4 and rebroadcast the signals to the access point device 2 or any other one or more client devices 4.

The user interface 46 can include, but is not limited to, one or more push buttons, a keyboard, a keypad, an LCD, a TFT, an LED, an HD or other similar display device including a display device having touch screen capabilities so as to allow interaction between a user and the extender access point device 3. The power supply 47 supplies power to the internal components of the wireless extender access point device 3 through the internal bus 53. The power supply 47 can be connected to an electrical outlet (for example, either directly or indirectly by way of another device) via a cable or wire. The network interface 48 can include various network cards, interfaces, and circuitry implemented in software and/or hardware to enable communications with the client device 4 and the access point device 2 using the communication protocols in accordance with connection 9 (for example, as described with reference to FIG. 1). For example, the network interface 48 can include multiple radios or sets of radios (for example, a 2.4 GHz radio, one or more 5 GHz radios, and/or a 6 GHz radio), which may also be referred to as wireless local area network (WLAN) interfaces. One radio or set of radios (for example, 5 GHz and/or 6 GHz radio(s)) provides a backhaul connection between the wireless extender access point device 3 and the access point device 2, and optionally other wireless extender access point device(s) 3. Another radio or set of radios (for example, 2.4 GHz, 5 GHZ, and/or 6 GHz radio(s)) provides a fronthaul connection between the extender access point device 3 and one or more client device(s) 4.

The memory 49 can include a single memory or one or more memories or memory locations that include, but are not limited to, a RAM, a DRAM, a memory buffer, a hard drive, a database, an EPROM, an EEPROM, a ROM, a flash memory, logic blocks of an FPGA, hard disk or any other various layers of memory hierarchy. The memory 49 can be used to store any type of instructions, software, or algorithm including software 50 associated with controlling the general functions and operations of the wireless extender access point device 3 in accordance with the embodiments described in the present disclosure. In one or more embodiments, extender access point device 3 is a network device and software 50 includes one or more instructions for establishing a connection with the access point device 2 and/or a client device 4.

The controller 51 controls the general operations of the wireless extender access point device 3 and can include, but is not limited to, a CPU, a hardware microprocessor, a hardware processor, a multi-core processor, a single core processor, an FPGA, a microcontroller, an ASIC, a digital signal processor (DSP), or other similar processing device capable of executing any type of instructions, algorithms, or software for controlling the operation and functions of the wireless extender access point device 3 in accordance with the embodiments described in the present disclosure. General communication between the components (for example, 46-51) of the extender access point device 3 may be established using the internal bus 53.

The access point device 2 can be, for example, a hardware electronic device that can combine one or more functions of any of a modem, a gateway, an access point (AP), a router, or combinations thereof for providing content received from the content provider (ISP) 1 to network or wireless devices (for example, extender access point devices 3, client devices 4) in the system. It is also contemplated by the present disclosure that the access point device 2 can include the function of, but is not limited to, an IP/QAM STB, an SMD, or any other decoder that is capable of decoding audio/video content, and playing OTT or MSO provided content.

As shown in FIG. 2, the access point device 2 includes a user interface 20, a network interface 21, a power supply 22, a wide area network (WAN) interface 23, a memory 24, and a controller 26. The user interface 20 can include, but is not limited to, one or more push buttons, a keyboard, a keypad, an LCD, a TFT, an LED, an HD or other similar display device including a display device having touch screen capabilities so as to allow interaction between a user and the access point device 2. In one or more embodiments, the user interface 20 provides an interface, such as a command-line interface, a graphical user interface, an interface output port for connection to a display, and/or any other type of user interface. In one or more embodiments, access point device 2 communicates with a client device 4 to provide information associated with a location of the access point device 2 such that the client device 4 can determine a change in location of the access point device 2 and/or determine a power allowance so as to configure the access point device 2, according to one or more aspects of the present disclosure.

The network interface 21 may include various network cards, and circuitry implemented in software and/or hardware to enable communications with the extender access point device 3 and the client device 4 using the communication protocols in accordance with connection 9 (for example, as described with reference to FIG. 1). Additionally, the various network cards, interfaces, and circuitry of the network interface 21 enable communications with a client device 4 (for example, a mobile device) using the one or more communication protocols in accordance with connection 9 (for example, as described with reference to FIG. 1). For example, the network interface 21 can include an Ethernet port (also referred to as a LAN interface) and multiple radios or sets of radios (for example, a 2.4 GHz radio, one or more 5 GHz radios, and/or a 6 GHz radio, also referred to as WLAN interfaces). One radio or set of radios (for example, 5 GHz and/or 6 GHz radio(s)) provides a backhaul connection between the access point device 2 and the wireless extender access point device(s) 3. Another radio or set of radios (for example, 2.4 GHz, 5 GHZ, and/or 6 GHz radio(s)) provides a fronthaul connection between the access point device 2 and one or more client device(s) 4. In one or more embodiments, the network interface 21 interfaces with a network resource 6.

The power supply 22 supplies power to the internal components of the access point device 2 through the internal bus 27. The power supply 22 can be connected to an electrical outlet (for example, either directly or by way of another device) via a cable or wire. The wide area network (WAN) interface 23 may include various network cards, and circuitry implemented in software and/or hardware to enable communications between the access point device 2 and the ISP 1 using the wired and/or wireless protocols in accordance with connection 9 (for example, as described with reference to FIG. 1).

The memory 24 includes a single memory, one or more memories, or one or more memory locations that include, but are not limited to, a RAM, a DRAM, a memory buffer, a hard drive, a database, an EPROM, an EEPROM, a ROM, a flash memory, logic blocks of a FPGA, hard disk or any other various layers of memory hierarchy. The memory 24 can be a non-transitory computer-readable storage medium used to store any type of instructions, software, or algorithm including software 25 for providing a 6 GHz wireless frequency network based on a configuration (such as configuration application 32 that utilizes one or more configuration parameters 350 as discussed with reference to FIG. 3) by a client device 4. The controller 26 controls the general operations of the access point device 2 as well as connectivity to the network by one or more other network devices (wireless extender access point devices 3 and client device 4). The controller 26 can include, but is not limited to, a central processing unit (CPU), a network controller, a hardware microprocessor, a hardware processor, a multi-core processor, a single core processor, a FPGA, a microcontroller, an ASIC, a DSP, or other similar processing device capable of executing any type of instructions, algorithms, or software including the software 25 in accordance with the embodiments described in the present disclosure. Communication between the components (for example, 20-24, and 26) of the access point device 2 may be established using the internal bus 27. The controller 26 may also be referred to as a processor, generally.

FIG. 3 is a block diagram illustrating a location integrity system 360 for use in determining a change in location information of an access point device 2 of a network, for example, the network environment of FIG. 1 and/or FIG. 2, according to one or more aspects of the present disclosure. The location integrity system 360 can be part of or included within any of an access point device 2, a proxy device (such as a client device 4), any other network device capable of determining a change in location of access point device 2 according to one or more aspects of the present disclosure, or both.

As shown in FIG. 3, the location integrity system 360 includes a memory 310, a controller 333, a network interface 330, a power supply 328 (such as a rechargeable battery), a user interface 329, for example, a camera 324 (or any other device for receiving/recording a visual image) and/or an input/output (I/O) interface 322, and one or more sensors 340. The one or more sensors 330 can include a global positioning system (GPS) receiver 320, one or more accelerometers 324, a compass or magnetometer 326, any other sensor, or any combination thereof. In one or more embodiments, any of the one or more sensors 340 can be part of a single device or one or more devices. The memory 310 can be a computer-readable memory for storing software or one or more computer-readable instructions executable by the controller 333. For example, a location integrity system 360 can comprise hardware, software, or both and can include, but is not limited to, a location integrity application 320 and one or more location integrity parameters 370 for use by the location integrity application 320, for example, any one or more measurements or data received from any of the one or more sensors 340, an access point device 2, a network resource 6, a database, any other network device capable of sending one or more measurements or data associated with a location and/or a power allowance associated with the access point device 2, or any combination thereof. Any one or more of the components of the location integrity system 360 can be implemented by software, hardware, or a combination thereof. In one or more embodiments, any one or more components of location integrity system 360 are included within single device/component or multiple devices/components.

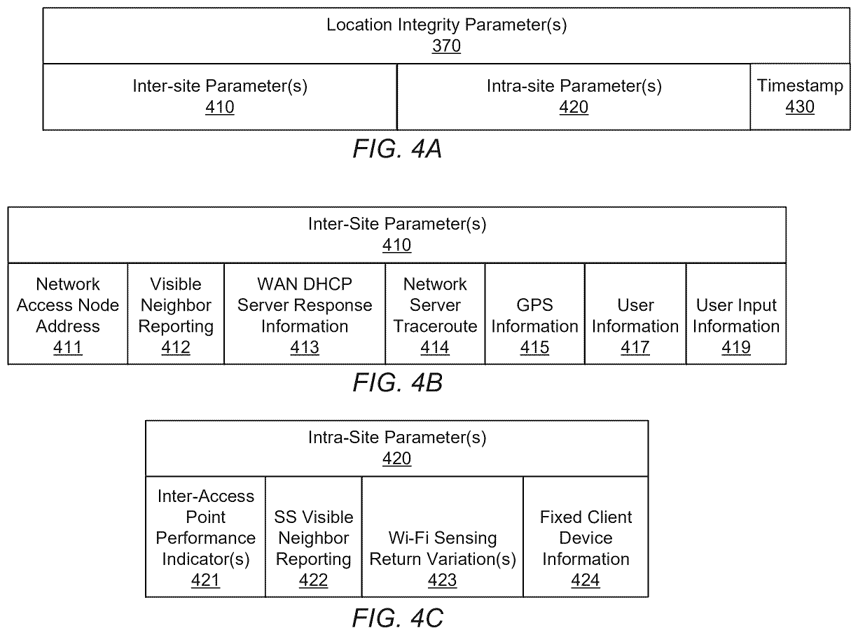

FIGS. 4A, 4B, and 4C illustrate a diagram for one or more location integrity parameters 370 of a location integrity system 360 for use in determining a change in a location of an access point device 2 in a network environment, according to one or more aspects of the present disclosure. As illustrated in FIG. 4A, the one or more location integrity parameters 370 can comprise any of one or more inter-site parameters 410, one or more intra-site parameters 420, a timestamp 430, or any combination thereof. The one or more inter-site parameters 410 are parameters associated with or indicative of a transition of an access point device 2 to a different site location, a location outside of the previous site. The one or more intra-site parameters 420 are associated with or indicative of a transition of an access point device 2 to a different location within a site. For example, any one or more of the location integrity parameters can be determined based on information received from a network device, such as an access point device, an extender access point device 3, or both), for example, based on any of a TR-069 protocol, a TR-369 protocol, a simple network management protocol (SNMP), an extensible messaging and presence protocol (XMPP), any other protocol that allows for the retrieval of information, or any combination thereof.

The one or more inter-site parameters 410 of FIG. 4B can comprise coarse values that are used by a location integrity system 360 to determine a change in location of the access point device 2 to a different location outside of the previous site. As illustrated in FIG. 4B, the one or more inter-site parameters 410 can comprise any of a network access node address 411, a visible neighbor reporting 412, a WAN dynamic host configuration protocol (DHCP) server response information 413, a network server traceroute 414, a GPS information 415, a user information 417, a user input information 419, or any combination thereof.

A network access node address 411 can indicate a network node address. For example, from the point of view of the access point device 2, the network access node address 411 can indicate the closest endpoint in a mesh network (for example, the first hop node). The location integrity system 360 can determine that a current network access node address does not match a stored network access node address 411 and thus determine that the access point device has a change in site location. The network access node address 411 can comprise any of a cable modem termination system (CMTS) line card media access control (MAC) address, a digital subscriber line access multiplexer (DSLAM) physical layer (PHY) address, an optical line terminal (OLT) MAC address, an optical network terminal (ONT) MAC address, an e/gNodeB (radio base station in 5G new radio (NR) networks) address, or any combination thereof. The network access node address 411 can be accessed by the access point device 2 which has a direct connection to the network

The visible neighbor reporting 412 (overlapping basic service set (OBSS)) can indicate one or more basic service set identifiers (BSSIDs) associated with one or more neighboring access point devices. The one or more visible neighbor reporting 412 can have a different count/set depending on a particular location. The visible neighbor reporting 412 can be a result of off or on-channel scans. A neighbor access point device can add and/or remove one or more network devices which changes the BSSID information. However, a change can be ignored by the location integrity system 360 if other BSSIDs remain unchanged. These visible neighbor reporting 412 can be determined by the access point device 2 and/or an extender access point device (wireless extenders), as during an on-channel and/or an off-channel scan for OBSS.

The WAN DHCP server response information 413 can comprise a DHCP MAC address (presumably the access node MAC address), a router internet protocol (IP) (option 6 (router IP address)—DHCP option), or both. WAN DHCP server response information 413 can be determined by the access point device 2 based on a direct interaction with a WAN DHCP server.

A network server traceroute 414, for example, to given network server can indicate a set of IP addresses from a source to a destination along a network router path, for example, focusing on a response for only one or more hops given that an IP route can be dynamically altered by the routing logic. The network server traceroute 414 can be determined by the access point device 2 based on network diagnostics functionality of the access point device 2 that includes, but is not limited to, functionality associated with a traceroute.

A GPS information 415 can indicate one or more coordinates obtained from any of the location integrity services application 370, one or more sensors 340, the access point device 2, or any combination thereof. The location integrity application 320 can maintain active knowledge of the latest or current location information and use this information when secure, coresident contact with the access point device is present. This location information can only be used when the location information is timely or not stale. In one or more embodiments, one or more location information can be utilized, for example, the location integrity application 320 can choose any one or more of the one or more location information for use in determining a change in the location of the access point device. The GPS information 415 can be determined from a client device 4 that comprises a GPS receiver that is locally connected (for example, via a Wi-Fi connection) to the access point device 2 and is configured to receive, collect or otherwise obtain one or more location measurements while connected to the access point device 2. For example, the client device 4 can be positioned or disposed near a window or outside of the site or premises so as to receive the one or more location measurements.

The user information 417 can comprise an operator known billing address information associated with a location of a user (for example, this information can be hashed based). The user information 417 can be determined from a network resource 6, such as a server, that comprises information about an address associated with a client device 4. For example, the network resource 6 can be an operator billing system that comprises location information, such as an address, associated with a user 350 and/or a client device 4.

The user input information 419 (for example, information from a user entered via the location integrity application 320, for example, address information of a site associated with the access point device and/or user entered pre-check address information, such as in retail purchase pre-check), or any combination thereof. The user input information 419 can be determined from a client device 4 or a network resource 6 that has collected and stored the previously entered user input information 419 associated with a user 350 and/or a client device 4.

The one or more intra-site parameters 420 of FIG. 4C can comprise granular values that are used by a location integrity system 360 to determine a change in location of the access point device 2 to a location within the site. In one or more embodiments, the one or more inter-site parameters 420 are not determined when the location integrity system 360 determines that the access point device has been transitioned to or has a change in a location to a different site. As illustrated in FIG. 4C, the one or more intra-site parameters can comprise any of one or more inter-access point performance indicators 421, one or more service set visible neighbor reporting 422, one or more Wi-Fi sensing return variations 423, a fixed client device information 424, or any combination thereof.

The one or more inter-access point performance indicators 421 can comprise any of a received signal strength indicator (RSSI), a PHY rate, any other performance indicator, or any combination thereof. The one or more inter-access point performance indicators 421 can indicate a network performance associated with a measurement between a client device 4 and an access point device 2, an extender access point device 3, or both. Determining whether an inter-access point performance indicator 421 remains unchanged can comprise determining whether the inter-access point performance indicator 421 is outside of a threshold margin, within a threshold margin, any other percentage, or any other factor. The one or more inter-access point performance indicators 421 can be determined by the access point device and/or one or more extender access point device within a mesh network, for example, via EasyMesh/1905.1 information access.

The signal strength (SS) visible neighbor reporting 422 (OBSS with signal strength) can indicate one or more BSSIDs along with signal strength associated with one or more neighboring access point devices. The one or more SS visible neighbor reporting 422 can have a different count/set depending on a particular location. The SS visible neighbor reporting 422 can be a result of off or on-channel scans. A neighbor access point device can add and/or remove one or more network devices which changes the BSSID information. However, a change can be ignored by the location integrity system 360 if other BSSIDs associated beacon signal strength information remain unchanged. Determining whether the SS visible neighbor reporting 422 remains unchanged can comprise determining whether the SS visible neighbor reporting 422 is outside of a threshold margin, within a threshold margin, any other percentage, or any other factor. The SS visible neighbor reporting 422 can be determined by a network device, such as the access point device and/or one or more extender access point device, as the network device performs an on-channel or off-channel scan.

The one or more Wi-Fi sensing return variations 423 can indicate one or more local environment sounding information. Determining whether a Wi-Fi sensing return variation 423 remains unchanged can comprise determining whether the Wi-Fi sensing return variation 423 is outside of a threshold margin, within a threshold margin, any other percentage related to the difference, or any other factor. The one or more Wi-Fi sensing return variations 423 can be determined by the access point device and/or one or more extender access point device using Wi-Fi location sounding techniques.

The fixed client device information 424 can comprise information associated with one or more fixed (or stationary) client devices, for example, one or more WLAN fixed client devices. The information can comprise RSSI, PHY rate, or both associated with the one or more fixed client devices. A fixed client device can comprise any of a set-top box, a printer, an IoT device, any other generally non-mobile device, or any combination thereof. In one or more embodiments the one or more fixed client devices are determined based on a detected device type, for example, any of deep packet inspection (DPI), host name, RSSI variation, any other information, or any combination thereof. The fixed client device information 424 can comprise a time duration such that a network device is detected as a fixed client device based on existence of the fixed client device within the network for the time duration. Determining whether the fixed client device information 424 unchanged can comprise determining whether the fixed client device information 424 is outside of a threshold margin, within a threshold margin, any other percentage related to the difference, or any other factor. The fixed client device information 424 can be determined by an access point device that has knowledge of one or more stationary network devices and has access to RSSI and/or PHY rate information associated with these one or more stations devices (for example, via EasyMesh/1905.1 information access).

In one or more embodiments, to avoid a false positive change in location (one or more location integrity parameters 370 indicate that the access point device has a change in location), the location integrity system 360 can base a determination of a change in location of the access point device 2 on a plurality of location integrity parameters 370. As the intra-site parameters 420 are highly variable, the comparison to a threshold margin can be made after a period of time, based on a plurality of measurements, or both. The location integrity system 360 can also determine a change in location of an access point device 2 based on any one or more inter-site parameters 410 and any one or more intra-site parameters 420. If the inter-site parameters 410 indicate a change in location, then the location integrity system 360 can optionally omit analysis based on the intra-site parameters 420 as the inter-site parameters 410 are coarse. Additionally, based on a type of AFC frequency and/or power mask previously received by a location integrity system 360, the access point device 2, or both, for an access point device 2, the location integrity system 360 can omit determining the one or more intra-site parameters 420 as the granularity or accuracy provided by the one or more intra-site parameters 420 is not required.

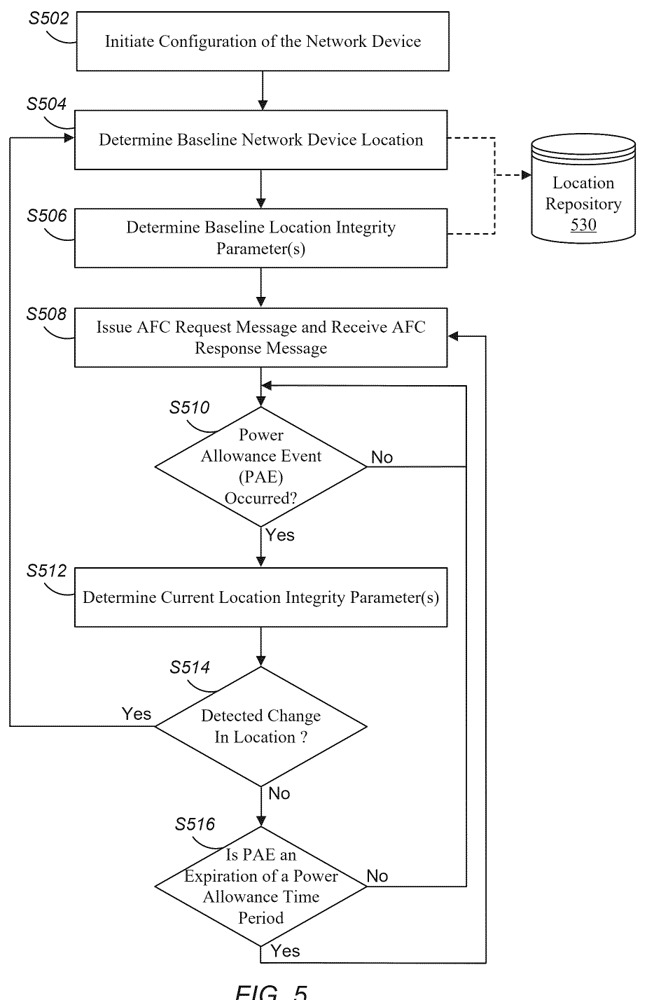

FIG. 5 is a flow diagram for detecting a change in location of an access point device 2 using a location integrity system 360, according to one or more aspects of the present disclosure. At step S502, the location integrity system 360 initiates a configuration of a network device that must adhere to one or more AFC constraints. The location integrity system 360 can be any of a distinct device or hardware, software, or both, included within or as part of a proxy device (such as a client device 4, for example, a mobile device associated with a user 350), an access point device 2, any other network device, or any combination thereof.

At step S504, configuration or setup of the network device can continue with the location integrity system 360 determining a baseline network device location. The baseline network device location can comprise GPS information and an error offset (such as a margin of error) associated with the baseline network device location. The baseline network device location is the initial or last known location of the network device. The baseline network device location can be stored in a location repository 530 that is remote from (such as at a network resource 6) or local to (such as in a memory 310) the location integrity system 360, the access point device 2, or both. According to one or more aspects of the present disclosure, the baseline network device location can be determined, such as updated or changed, based on the current location of the network device.

At step S506, configuration or setup of the network device can continue with the location integrity system 360 determining one or more baseline location integrity parameters 370 associated with the network device. The one or more baseline location integrity parameters 370 are the initial or last known one or more location integrity parameters 370 associated with the network device. The one or more baseline location integrity parameters 370 can be stored in a location repository 530 that is remote from the location integrity system 360 (such as at a network resource 6) or local to the location integrity system 360 (such as in a memory 310), or both. In one or more embodiments, determining the one or more baseline location integrity parameters 370 can comprise analyzing information received from the network device, a proxy device, a network resource, any other device, or any combination thereof or updating the one or more baseline location integrity parameters 370 with the one or more current location integrity parameters determined in step S512. In one or more embodiments, the updating occurs after comparing the timestamp 430 associated with the one or more current location integrity parameters to a location integrity parameter threshold such that the update only occurs if the one or more current location integrity parameters are valid (the timestamp has not reached or exceeded the location integrity parameter threshold), otherwise the analysis must be performed to determine the one or more baseline location integrity parameters 370. According to one or more aspects of the present disclosure, the one or more baseline location integrity parameters can be determined, such as updated or changed, based on the current location integrity parameters associated with the network device

At step S508, during initiation, setup and/or configuration of the network device or based on any other one or more power allowance events, the location integrity system 360 issues or sends an AFC request message to an AFC management system to obtain a power allowance (such as an EIRP mask) for a network device. For example, the AFC request message can be an AFC Available Spectrum Inquiry (ASI) request message. The AFC request message can comprise any of one or more location integrity parameters 370, a baseline network device location (for example, that includes any of an x-, y-, and/or -z coordinate, a height information, an error offset, or any combination thereof), a MAC address, a serial number or associated serial number identifier, a regulatory certification identifier (such as an FCC certification identifier), any other identifier and/or location information, or any combination thereof. In response to the AFC Request Message, the location integrity system 360 receives an AFC response message with an assigned power allowance based on the baseline network device location. A power allowance time period can be associated with the AFC response message such that the network device is permitted to utilize the assigned power allowance for the duration of the power allowance time period. The power allowance time period can be saved in a non-volatile memory, for example, a memory 310. The power allowance time period can be associated with any of a flag, a semaphore, a timer, an alert, an alarm, a threshold, any other indicator of expiration of the power allowance time period, or any combination thereof.

At step S510, the location integrity system 360 determines if a power allowance event (PAE) occurred. A power allowance event can indicate that a network device can has experienced or detected any of a reboot, a restart, an expiration of a power allowance time period, a change in location, any other event, or any combination thereof. If no power allowance event has occurred, the location integrity system 360 continues to loop at step S510.

If a power allowance event has occurred, the location integrity system 360 continues to step S512, where the location integrity system 360 determines one or more current location integrity parameters 370. In one or more embodiments, any one or more location integrity parameters 370 can be requested from the network device, such as any of the access point device associated with the power allowance event, one or more proxy devices, such as a client device 4, a network resource 6, any other device that is capable of providing location information associated with the network device, or any combination thereof. The location integrity system 360 can associate a timestamp 430 with the one or more current location integrity parameters. The present disclosure also contemplates that the one or more current location integrity parameters, including the associated timestamp, can be stored in the location repository 530.

At step S514, the location integrity system 360 can detect whether a change in location of the network device based on a comparison of the one or more current location integrity parameters from step S512 and the one or more baseline location integrity parameters from step S506. In one or more embodiments, the comparison is based on a threshold or a threshold range such that nonconsequential, insubstantial, or other insignificant changes in the location integrity parameters are not considered to indicate that the network device has experienced a change in location. In one or more embodiments, the location integrity system 360 compares a timestamp 430 to a location integrity parameter threshold to determine if a time delay has occurred such that if the timestamp has reached, exceeded or both the location integrity parameter threshold the location integrity system 360 returns to step S512. If the location integrity system 360 determines that a change in location of the network device has occurred, the location integrity system 360 continues to step S504. In one or more embodiments, the location integrity system 360 delays for a set time, but no more than any remaining time of the power allowance time period, before continuing to step S504. In one or more embodiments, the location integrity system 360 continues without delay, in real-time, or substantially real-time to step S504.

If the location integrity system 360 determines that a change in location has not occurred, the location integrity system 360 continues to step S516. At step S516, the location integrity system 360 determines if the power allowance event is an expiration of a power allowance time period. If the power allowance time period has expired, whether or not a change in location has occurred, the location integrity system 360 will continues to step S508. If the power allowance event is not an expiration of a power allowance time period, the location integrity system 360 continues to step S510 as no change in location of the network device was detected at step S514.

In this way, an AFC request message is issued or sent by the location integrity system 360 when the network device has a change in location and/or a power allowance time period has expired. As illustrated in FIG. 5, the location integrity system 360 will not issue or send an AFC request message due to an occurrence of an inconsequential event, such as a power outage or a fluctuation in power in an area, an inadvertent disconnection, or any other inconsequential event when such an event occurs within the power allowance time period and do not result in a change in location of the network device. The location integrity system 360 sends an AFC request message based on comparison of one or more current location integrity parameters to one or more baseline location integrity parameters such that a change in location of the network device is indicated or an expiration to a power allowance timer period.

In one or more aspects of the present disclosure, the location integrity system 360 can perform step S516 prior to or substantially simultaneously with step S514. If a change in location is detected at the same time or substantially simultaneously with the expiration of a power allowance time period the process can continue to steps S504 and S506 so that the baseline network device location, the one or more baseline location integrity parameters, or both can be updated prior to issuing an AFC request message at step S508 so that the AFC request message comprise the current location of the network device.

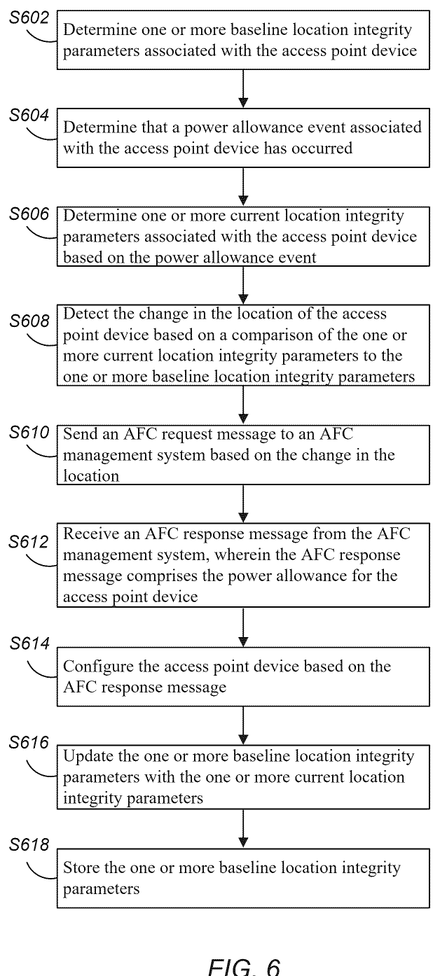

FIG. 6 is a flow chart illustrating a method for a location integrity system 360 to determine a change in a location of an access point device in a network, according to one or more aspects of the present disclosure. At step S602, the location integrity system 360 determines one or more baseline location integrity parameters associated with the access point device in a network. In one or more aspects, the access point device 2 comprises a plurality of network devices, such as a plurality of access point devices 2. Prior to, after, at substantially the same time, or any other time, as step S602, the location integrity system 360 can determine a baseline location of the access point device 2.

At step S604, the location integrity system 360 determines or detects that a power allowance event associated with the access point device has occurred. The location integrity system 360 can determine such a power allowance event based on, for example, receiving an event message from the access point device that indicates the type of event. The power allowance event can comprise any of a reboot, a power sequence, a location change, an expiration of a power allowance time period, or any combination thereof.

At step S606, the location integrity system 360 determines one or more current location integrity parameters associated with the access point device based on the power allowance event, for example, as discussed with references to FIGS. 4A, 4B and 4C.

At step S608, the location integrity system 360 detects the change in the location of the access point device based on a comparison of the one or more current location integrity parameters to the one or more baseline location integrity parameters. For example, the comparison can indicate that a difference of at least one of the one or more location integrity parameters and a corresponding at least one of the one or more current location integrity parameters is at or above an associated threshold.

At step S610, the location integrity system 360 sends an AFC request message to an AFC management system based on the change in the location. The AFC request message can comprise a location of the access point device 2, such as GPS information indicative of a location of the access point device 2, an error offset (such as a margin of error) associated with the GPS information or any other determination of the location of the access point device 2, or both.

At step S612, the location integrity system 360 receives an AFC response message from the AFC management system, wherein the AFC response message comprises a power allowance for the access point device 2. In one or more embodiments, receiving the AFC response message restarts or resets the power allowance time period.

At step S614, the location integrity system 360 configures the access point device 2 based on the AFC response message. The AFC response message, for example, can comprise an EIRP mask and this mask can be used to set the power allowance for the access point device 2.

At step S616, the location integrity system 360 updates the one or more baseline location integrity parameters with the one or more current location integrity parameters. The updating the one or more baseline location integrity parameters can be based on a timestamp associated with the one or more current location integrity parameters. For example, a timestamp can be associated based on a clock, a real-time clock (RTC), Network Time Protocol (NTP), any other time value, or any combination thereof of the location integrity system. The timestamp can be associated at or substantially at time of the update. The location integrity parameters can comprise one or more inter-site parameters (such as any of a network node address, a visible neighbor reporting, a wide area network (WAN) dynamic host configuration protocol (DHCP) server response information, a network server traceroute, a global positioning system information, a user information, a user input information, or any combination thereof), one or more intra-site parameters (such as any of one or more performance indicators, a signal strength visible neighbor reporting, one or more wireless fidelity sensing return variation parameters, a fixed client device information, or any combination thereof), and a timestamp.

At step S618, the location integrity system 360 stores the one or more baseline location integrity parameters. For example, the one or more baseline location integrity parameters can be stored at a network resource, such as in a location repository 530.

In FIGS. 5 and 6, the location integrity system 360 can be part of or included within any network device such as any of an access point device 2, a proxy device, such as a client device 4 (including, but not limited to, any of a smart phone, a tablet, any other mobile device, or any combination thereof), any other network device, or any combination thereof. FIGS. 5 and 6, it is assumed that any one or more devices include their respective controllers and/or processor and their respective software (such as one or more computer-readable instructions) stored in their respective memories, as discussed above in reference to FIGS. 1-3, which when executed by their respective controllers perform one or more functions or operation in accordance with the example embodiments of the present disclosure. A processor executes one or more computer-readable instructions, stored in a memory, for example, a non-transitory computer-readable memory as discussed with reference to FIGS. 1-3, that when executed by the processor perform and/or cause a location integrity system 360 to perform one or more of the operations of steps S502-S516 and/or steps S602-S618. In one or more embodiments, the one or more computer-readable instructions may be one or more software applications. While the steps of FIGS. 5 and 6 are presented in a certain order, the present disclosure contemplates that any one or more steps can be performed simultaneously, substantially simultaneously, repeatedly, in any order or not at all (omitted).

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. A method for a location integrity system to detect a change in a location of an access point device comprising:
determining one or more baseline location integrity parameters associated with the access point device;
determining that a power allowance event associated with the access point device has occurred;
determining one or more current location integrity parameters associated with the access point device based on the power allowance event;
detecting the change in the location of the access point device based on a comparison of the one or more current location integrity parameters to the one or more baseline location integrity parameters;
sending an AFC request message to an AFC management system based on the change in the location;
receiving an AFC response message from the AFC management system, wherein the AFC response message comprises the power allowance for the access point device; and
configuring the access point device based on the AFC response message.

2. The method of claim 1, further comprising:
updating the one or more baseline location integrity parameters with the one or more current location integrity parameters; and
storing the one or more baseline location integrity parameters.

3. The method of claim 2, wherein the updating the one or more baseline location integrity parameters is based on a timestamp associated with the one or more current location integrity parameters.

4. The method of claim 1, wherein at least one of:
the power allowance event comprises any of a reboot, a power sequence, a location change, or any combination thereof; and
the one or more location integrity parameters comprise one or more inter-site parameters, one or more intra-site parameters, and a timestamp.

5. The method of claim 4, wherein the one or more inter-site parameters comprise any of a network node address, a visible neighbor reporting, a wide area network (WAN) dynamic host configuration protocol (DHCP) server response information, a network server traceroute, a global positioning system information, a user information, a user input information, or any combination thereof.

6. The method of claim 4, wherein the one or more intra-site parameters comprise any of one or more performance indicators, a signal strength visible neighbor reporting, one or more wireless fidelity sensing return variation parameters, a fixed client device information, or any combination thereof.

7. The method of claim 1, wherein the comparison indicates that a difference of at least one of the one or more location integrity parameters and a corresponding at least one of the one or more current location integrity parameters is at or above an associated threshold.

8. A location integrity system to detect a change in a location of an access point device comprising:
a memory; and
a processor configured to execute one or more instructions stored on the memory to cause the location integrity system to:
determine one or more baseline location integrity parameters associated with the access point device;
determine that a power allowance event associated with the access point device has occurred;
determine one or more current location integrity parameters associated with the access point device based on the power allowance event;
detect the change in the location of the access point device based on a comparison of the one or more current location integrity parameters to the one or more baseline location integrity parameters;
send an AFC request message to an AFC management system based on the change in the location;
receive an AFC response message from the AFC management system, wherein the AFC response message comprises the power allowance for the access point device; and
configure the access point device based on the AFC response message.

9. The location integrity system of claim 8, wherein the processor is further configured to execute the one or more instructions to further cause the location integrity system to:
update the one or more baseline location integrity parameters with the one or more current location integrity parameters; and
store the one or more baseline location integrity parameters.

10. The location integrity system of claim 9, wherein the updating the one or more baseline location integrity parameters is based on a timestamp associated with the one or more current location integrity parameters.

11. The location integrity system of claim 8, wherein at least one of:
the power allowance event comprises any of a reboot, a power sequence, a location change, or any combination thereof; and
the one or more location integrity parameters comprise one or more inter-site parameters, one or more intra-site parameters, and a timestamp.

12. The location integrity system of claim 11, wherein the one or more inter-site parameters comprise any of a network node address, a visible neighbor reporting, a wide area network (WAN) dynamic host configuration protocol (DHCP) server response information, a network server traceroute, a global positioning system information, a user information, a user input information, or any combination thereof.

13. The location integrity system of claim 11, wherein the one or more intra-site parameters comprise any of one or more performance indicators, a signal strength visible neighbor reporting, one or more wireless fidelity sensing return variation parameters, a fixed client device information, or any combination thereof.

14. The location integrity system of claim 8, wherein the comparison indicates that a difference of at least one of the one or more location integrity parameters and a corresponding at least one of the one or more current location integrity parameters is at or above an associated threshold.

15. A non-transitory computer-readable medium of a location integrity system storing one or more computer-readable instructions for configuring a power allowance for an access point device, that when executed by a processor, cause the processor to perform one or more operations comprising:
determining one or more baseline location integrity parameters associated with the access point device;
determining that a power allowance event associated with the access point device has occurred;
determining one or more current location integrity parameters associated with the access point device based on the power allowance event;
detecting the change in the location of the access point device based on a comparison of the one or more current location integrity parameters to the one or more baseline location integrity parameters;
sending an AFC request message to an AFC management system based on the change in the location;
receiving an AFC response message from the AFC management system, wherein the AFC response message comprises the power allowance for the access point device; and
configuring the access point device based on the AFC response message.

16. The non-transitory computer-readable medium of claim 15, wherein the one or more computer-readable instructions when executed by the processor, further cause the processor to perform one or more operations further comprising:
updating the one or more baseline location integrity parameters with the one or more current location integrity parameters; and
storing the one or more baseline location integrity parameters.

17. The non-transitory computer-readable medium of claim 16, wherein the updating the one or more baseline location integrity parameters is based on a timestamp associated with the one or more current location integrity parameters.

18. The non-transitory computer-readable medium of claim 15, wherein at least one of:
the power allowance event comprises any of a reboot, a power sequence, a location change, or any combination thereof; and
the one or more location integrity parameters comprise one or more inter-site parameters, one or more intra-site parameters, and a timestamp.

19. The non-transitory computer-readable medium of claim 18, wherein at least one of:
the one or more inter-site parameters comprise any of a network node address, a visible neighbor reporting, a wide area network (WAN) dynamic host configuration protocol (DHCP) server response information, a network server traceroute, a global positioning system information, a user information, a user input information, or any combination thereof; and
the one or more intra-site parameters comprise any of one or more performance indicators, a signal strength visible neighbor reporting, one or more wireless fidelity sensing return variation parameters, a fixed client device information, or any combination thereof.

20. The non-transitory computer-readable medium of claim 15, wherein the comparison indicates that a difference of at least one of the one or more location integrity parameters and a corresponding at least one of the one or more current location integrity parameters is at or above an associated threshold.
